(19) United States
(12) Patent Application Publication
(10) Pub. No.: US 2025/0319537 A1
(43) Pub. Date: Oct. 16, 2025

(54) WIRELESS SAW SAFETY SYSTEM AND METHOD

(71) Applicant: HOLLYMATIC CORPORATION, Countryside, IL (US)

(72) Inventors: Victor GUYNN, Romeoville, IL (US); David BAARMAN, Fennville, MI (US); Erik BAUER, Alto, MI (US)

(73) Assignee: HOLLYMATIC CORPORATION, Countryside, IL (US)

(21) Appl. No.: 18/631,909

(22) Filed: Apr. 10, 2024

(51) Int. Cl. B23D 59/00

(52) U.S. Cl. CPC B23D 59/001

(57) ABSTRACT

A saw safety system including a saw comprising a saw controller and a blade and an operator system comprising an operator device, gloves configured to be worn by an operator and configured to electrically connect to the operator device, a conductive surface grounded to the saw, and a conductive element configured to be worn by the operator and configured to ground the operator device through contact with the conductive surface, wherein the operator device is configured to: receive a first signal from the gloves; determine whether at least one of the gloves has contacted the blade based on the first signal received from the gloves; and cause, by sending a wireless signal to the saw controller based on determining that the at least one glove has contacted the blade, the saw controller to stop operation of the blade.

### BACKGROUND

### 1. Technical Field

Embodiments of the present disclosure relate to systems, methods, and apparatus for stopping a saw and monitoring a blade that may come into contact with human body parts. Embodiments of the present disclosure also relate to detection of signals at setup for calibration and operator sensor data.

### 2. Description of Related Art

Past solutions for attempting to safely stop injury to a user of equipment (e.g., a saw) range from vision systems and safety areas to more sophisticated monitoring equipment. When using prior monitors and connection methods, there is a compromise of these systems as they do not enable operator freedom. One of these prior methods includes connecting a device that sends a signal to be detected by a saw in order to stop the saw before damage occurs to the user. However, the prior monitors are limited to physical connections and have minimal freedom to operate. Other systems require the users to wear gloves all the way up the arms to prevent false trips.

Some known problems of the past technologies relate to misunderstandings of the relationship of the user to the saw as a circuit.

### SUMMARY

Embodiments of the present disclosure address several matters such as those described above, and other matters not described above. Embodiments of the present disclosure may be considered key solutions to past problems.

Some embodiments of the present disclosure relate to various ways to safely stop injury while using equipment (e.g., a saw).

Some embodiments provide a wireless saw safety system that includes a saw and an operator system, the operator system including a wireless operator device for delivering a detection signal. A saw controller of the saw may obtain the detection signal based on insulation of a glove of the operator system being pierced by a blade of the saw, and the signal is detected on a blade of the saw. The blade is isolated from ground and allows the detection signal to be monitored and, when the detection signal is recognized by the wireless operator device, the wireless saw safety system causes the saw controller to perform an emergency stop of the saw blade.

In some embodiments, the glove includes a conductive glove layer that is electrically connected to at least one processor (e.g., of the wireless operator device). The saw blade is electrically isolated from an electrical ground on a pathway through the saw. The glove and the saw blade are configured to, in response to the glove contacting the saw blade, complete an electrical circuit that includes a pathway through the saw blade and the glove.

Embodiments of the present disclosure may include identification of the operator by a unique ID, a received signal strength indicator (RSSI) signal strength for proximity, and a physical enable push button to assure the physical presence of a wireless operator. Embodiments of the present disclosure may include monitoring methods, sensor types, signal resolution, and event tracking for determining quality of data gathered and resolution or quality of a safety solution. Embodiments of the present disclosure may implement additional controls such as, for example, a programmable and tunable fast Fourier transform (FFT) algorithm for frequency detection and programmable calibration circuits, which enable the wireless saw safety system to tune both operator broadcast signal frequency and amplitude as well as tuning the FFT for noise, frequency, samples, and consecutive good detections.

Embodiments of the present disclosure include communication systems, learning, and other various configurations, along with a cloud interface, that provide solutions for safely stopping injury to a user while using equipment that are safer, more adaptable, and easier to use.

According to embodiments of the present disclosure, a saw safety system is provided. The saw safety system includes a saw comprising a saw controller and a blade; and an operator system comprising: an operator device, gloves configured to be worn by an operator and configured to electrically connect to the operator device, a conductive surface grounded to the saw, and a conductive element configured to be worn by the operator and configured to ground the operator device through contact with the conductive surface, wherein the operator device is configured to: receive a first signal from the gloves; determine whether at least one of the gloves has contacted the blade based on the first signal received from the gloves; and cause, by sending a wireless signal to the saw controller based on determining that at least one the gloves has contacted the blade, the saw controller to stop operation of the blade.

According to one of more embodiments of the present disclosure, the gloves include an insulated layer and a conductive layer.

According to one of more embodiments of the present disclosure, the insulated layer surrounds the conductive layer and the insulator layer is configured to contact a skin surface of the operator when the gloves are worn by the operator.

According to one of more embodiments of the present disclosure, the conductive layer is configured to contact a skin surface of the operator when the gloves are worn by the operator.

According to one of more embodiments of the present disclosure, the conductive element is connected to the operator device via a wire, and the operator device is grounded via the wire and the conductive element.

According to one of more embodiments of the present disclosure, the conductive element is a shoe strap and the operator device is configured to be grounded by the shoe strap through an electrical pathway that includes a body of the operator.

According to one of more embodiments of the present disclosure, the operator device is further configured to be mounted to a body of the operator.

According to one of more embodiments of the present disclosure, the operator system is configured to store a unique identifier that is associated with the operator in a memory, and send the unique identifier to the saw controller, and the saw controller is configured to determine whether the operator is authorized to operate the saw based on the unique identifier and allow operation of the saw by the operator based on determining that the operator is authorized to operate the saw.

According to one of more embodiments of the present disclosure, the operator device is configured to communicate with the saw controller via Bluetooth Low Energy (BLE) signals.

According to one of more embodiments of the present disclosure, the saw further includes capacitive plates, and the saw controller is further configured to verify proper grounding between the operator and the saw based on receiving a second signal via the capacitive plate, that is received based on the operator wearing the gloves and placing the gloves on the capacitive plates.

According to embodiments of the present disclosure, a method for stopping a saw including a saw controller and a blade is provided. The method includes receiving, by an operator device, a first signal from a glove worn by an operator via an electric pathway that connected the glove to the operator device; determining, by the operator device, whether the glove has contacted the blade based on the first signal that is received; and transmitting, from the operator device to the saw controller via wireless communication, a wireless signal based on determining that the glove has contacted the blade, and stopping, by the saw controller, movement of the blade based on receiving the wireless signal from the operator device.

According to one of more embodiments of the present disclosure, the saw further includes a capacitive plate, and the method further comprises: receiving, by the saw controller, a second signal via the capacitive plate, based on the operator wearing the glove and placing the glove on the capacitive plate; and verifying, by the saw controller, proper grounding between the operator and the saw based on the second signal.

According to one of more embodiments of the present disclosure, the glove includes an insulated layer and a conductive layer.

According to one of more embodiments of the present disclosure, the insulated layer surrounds the conductive layer and the insulator layer is configured to contact a skin surface of the operator when the glove is worn by the operator.

According to one of more embodiments of the present disclosure, the conductive layer is configured to contact a skin surface of the operator when the glove is worn by the operator.

According to one of more embodiments of the present disclosure, a conductive element worn by the operator is connected to the operator device via a wire, and the operator device is grounded via the wire and the conductive element

According to one of more embodiments of the present disclosure, the operator device is configured to be grounded by a shoe strap worn on a shoe of the operator through an electrical pathway that includes a body of the operator.

According to one of more embodiments of the present disclosure, the method further includes: sending, from the operator device to the saw controller, a unique identifier that is associated with the operator, and determining whether the operator is authorized to operate the saw based on the unique identifier and allowing operation of the saw by the operator based on determining that the operator is authorized to operate the saw.

According to one of more embodiments of the present disclosure, the operator device is further configured to be mounted to a body of the operator.

According to embodiments of the present disclosure, a non-transitory computer-readable storage medium is provided. The non-transitory computer-readable storage medium storing computer code which, when executed by at least one processor, causes the at least one processor to at least: receive a first signal from gloves worn by an operator via an electric pathway that connects the gloves to the at least one processor; determine whether at least one of the gloves has contacted a blade of a saw based on the first signal that is received; and transmit, via wireless communication, a command to the saw to stop movement of the blade based on determining that the at least one of the gloves has contacted the blade.

### BRIEF DESCRIPTION OF DRAWINGS

Embodiments will be more clearly understood from the following detailed description taken in conjunction with the accompanying drawings in which:

FIG. 1. illustrates a wireless saw safety system according to some embodiments;

FIG. 2 illustrates a block diagram of a wireless saw safety system according to some embodiments;

FIG. 3 illustrates a block diagram of a wireless saw safety system according to some embodiments;

FIG. 4 illustrates a block diagram of an operator device according to some embodiments;

FIG. 5 illustrates a block diagram of a saw controller according to some embodiments;

FIG. 6 illustrates a block diagram of a saw system and a saw controller according to some embodiments;

FIG. 7A illustrates a flow chart of a process performed by an operator device according to some embodiments;

FIG. 7B illustrates a flow chart of a process performed by a saw safety system according to some embodiments;

FIG. 8A illustrates a graph of a signal level according to some embodiments;

FIG. 8B illustrates a graph of a signal level according to some embodiments;

FIG. 8C illustrates a graph of a signal level according to some embodiments;

FIG. 9A illustrates an operator system according to some embodiments;

FIG. 9B illustrates an operator system according to some embodiments;

FIG. 10A illustrates gloves according to some embodiments;

FIG. 10B illustrates a cross section of material construction of the gloves according to some embodiments;

FIG. 10C illustrates a cross section of material construction of the gloves according to some embodiments;

FIG. 11A illustrates a grounding configuration of the saw safety system according to some embodiments;

FIG. 11B illustrates a conductive element for grounding according to some embodiments;

FIG. 11C illustrates a conductive element for grounding according to some embodiments;

FIG. 11D illustrates a conductive element for grounding according to some embodiments;

FIG. 12A illustrates a grounding configuration according to some embodiments;

FIG. 12B illustrates a grounding configuration according to some embodiments;

FIG. 12C illustrates a grounding configuration according to some embodiments;

FIG. 13 illustrates a chart of various signal ratios of shunted and non-shunted signals for the various grounding configurations.

### DETAILED DESCRIPTION

Directional terms, such as “vertical,” “horizontal,” “top,” “bottom,” “upper,” “lower,” “inner,” “inwardly,” “outer” and “outwardly,” are used to assist in describing embodiments of the present disclosure based on the orientation of the embodiments shown in the illustrations. The use of directional terms should not be interpreted to limit the embodiments of the present disclosure to any specific orientation(s).

For emergency/automatic-stop saws, a safety system for machinery may be provided in which some input to a controller triggers a sudden stop of a component, for example, a saw blade. The safety system may cause the saw to perform a sudden stop of the component by obtaining a signal from an electrically conductive glove and discerning whether a feature of the signal (e.g., voltage) indicates that the glove has come into contact with the component. In a saw safety system, the input may be the closure of an electrical circuit caused by physically touching the saw blade with the glove(s). For example, the glove comprises a conductive glove layer that is electrically connected a controller. The saw blade may be electrically isolated from an electrical ground on a pathway through the saw. The glove and the saw blade may be configured to, in response to the glove contacting the saw blade, complete an electrical circuit that includes a pathway through the saw blade and the glove. Also, the at least one processor may be configured to control a motor to stop rotating the saw blade in response to the electrical circuit being completed.

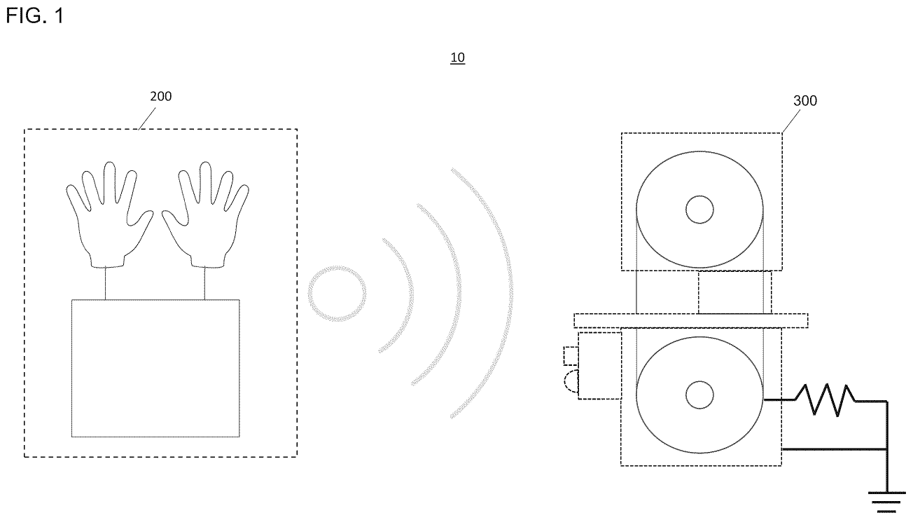

FIGS. 1-3 illustrate saw safety systems according to some embodiments of the present disclosure.

With references to FIG. 1, a saw safety system 10 may comprise a saw 300 and an operator system 200 (e.g., a glove system).

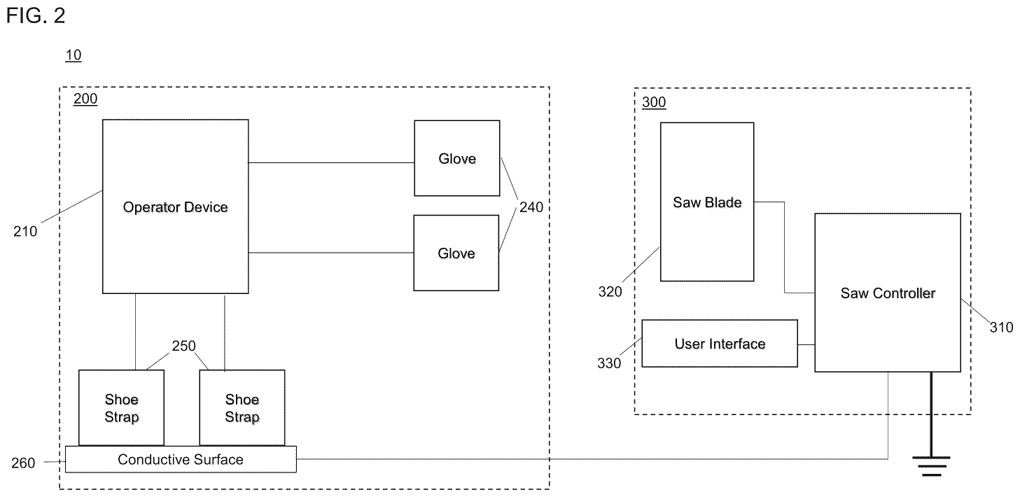

With reference to FIG. 2, the saw 300 may include a saw controller 310, a saw blade 320, and a user interface 330. The saw controller 310 may include one or more processors and a memory storing computer instructions that are configured to cause, when executed by the one or more processors, the saw controller 310 to perform its functions. The user interface 330 may include, for example, input devices (e.g., buttons or switches) for normal starts/stop operations and emergency stop operations and input devices (e.g., buttons and pairing switches) for initiating pairing operations between the saw 300 and the operator system 200. In some embodiments, the user interface 330 may include switches, a keyboard, a mouse, a touch screen display device, etc. The user interface 330 may include status indicators, for example, lights, speakers, displays, etc, to display saw information.

The operator system 200 may include an operator device 210 and gloves 240 (also referred to as insulating gloves). The operator device 210 may be configured to be mounted on the operator, for example, via a belt or waistband. The operator device 210 may include one or more processors and a memory storing computer instructions that are configured to cause, when executed by the one or more processors, the operator device 210 to perform its functions. The gloves 240 may be electrically conductive and electrically connected to the operator device 210 (e.g., via a wire(s)). A signal area of the gloves 240 is primarily between a wrist of the operator and a conductive portion of the gloves and fingers of the operator. This configuration enables a body of the operator to be used as a capacitive element enabling an electronic signal path. The selection of frequencies and signal strength supplied by the operator device 210 may be adjusted as required to maximize strength of the electronic signal path.

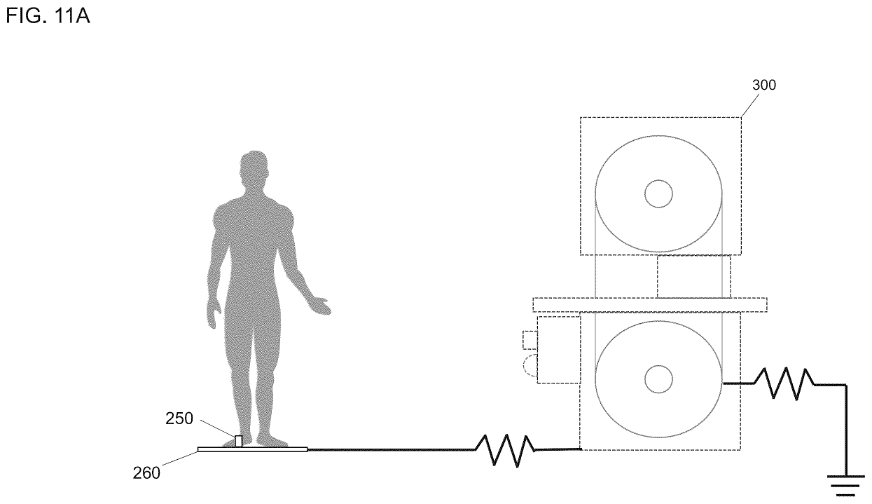

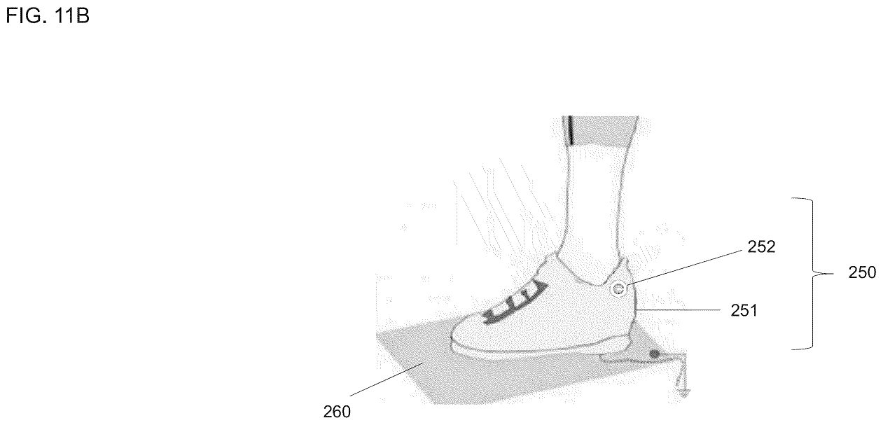

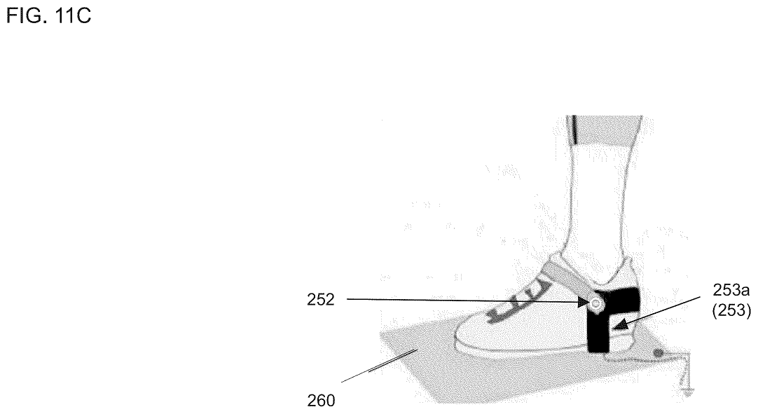

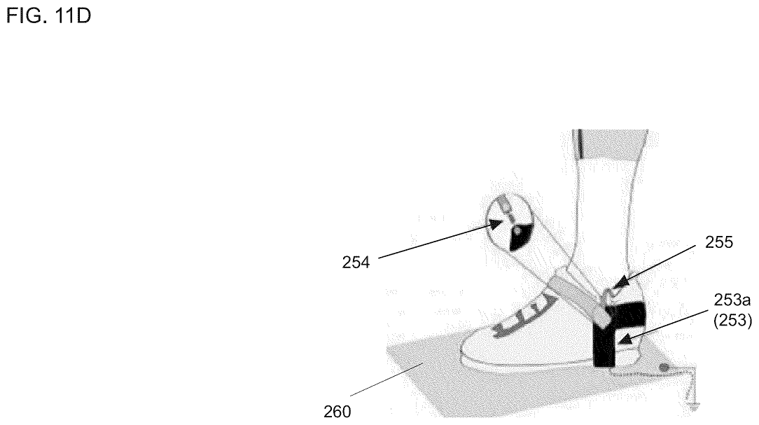

According to some embodiments, the operator system 200 may further include a conductive element 250 worn by the operator. The conductive element 250 may be, for example, a conductive shoe 251 and/or a shoe strap 253 (refer to FIGS. 11B-11D). The conductive shoe 251 may directly ground the operator device 210 without grounding the operator to establish a signal path. The conductive element 250 may be used for grounding the operator device 210 through the body of the operator and/or may directly ground the operator device 210, without grounding the operator, to establish the signal path. In some embodiments, the conductive shoe 251 may be provided in plural such as to include a right conductive shoe and a left conductive shoe. In some embodiments, the shoe strap 253 may be provided in plural such as to include a right foot shoe strap and left foot shoe strap.

The operator system 200 may further include a conductive surface 260 that connects (e.g., via a wire(s)) to the saw 300. The conductive surface 260 may be, for example, a static mat, or a metal grounded surface, and may be positioned in front of the saw 300 such that the operator stands on the conductive surface 260 (e.g., while wearing the conductive element 250) during operation of the saw 300, and thereby completes an electrical circuit with the saw blade 320 when the operator's insulating glove is penetrated and the conductive portion of the glove(s) 240 touches the saw blade 320. When the resistance to ground is less than the resistance to the signal path, the amplitude signal is reduced by the resistance to ground.

A signal ground path enables electronic monitoring of a signal by the operator device 210, and when the saw blade 320 is touched by the gloves 240, the signal is shunted to ground, losing signal amplitude which is detected by the operator device 210. The operator device 210 communicates to the saw controller 310 to initiate an emergency stop of the saw blade 320, also referred to as an E-Stop.

The operator device 210 may utilize a fast Fourier transform (FFT) algorithm to monitor a detection frequency of the signal and tune the frequency and amplitude of the operator device 210 broadcast signal. In some embodiments, the FFT algorithm may be tuned to reduce noise.

In some embodiments, the operator device 210 may generate the signal and the saw controller 310 may be configured to detect shunted signals on the saw blade 320 and initiate the E-Stop. The saw controller 310 may determine when the insulation of at least one of the gloves 240 is pierced, and the signal is detected on the blade. The saw blade 320 may be isolated from ground and may allow the signal to be monitored on the blade. When the signal is detected on the blade, the saw controller 310 may cause an emergency stop of the saw. Some embodiments may provide a wireless system that utilizes a grounded body with the gloves 240 that are modulated at a detection frequency. The saw blade 320 may be isolated with a resistance so that a signal can be easily detected using frequency filters (e.g. bandpass filters) and the FFT algorithm, as discussed in the present disclosure regarding the operator device 210, to filter noise and increase sensitivity. Other methods can also be utilized for frequency detection such as counters and timers determining the period and frequency. Frequency counters may also be used.

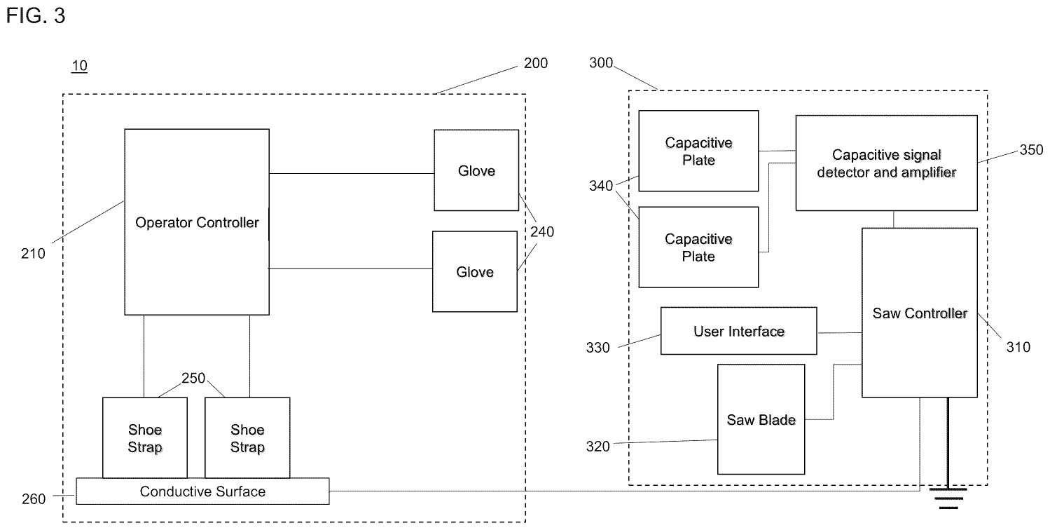

With reference to FIG. 3, in some embodiments, the saw 300 may further include capacitive plates 340 (e.g., a left plate and a right plate corresponding to the operator's hands) and a capacitive signal detector and amplifier 350. The gloves 240 may be configured to cooperate with the capacitive plates 340 and the capacitive signal detect and amplifier 350 for glove safety and validation purposes. For example, the operator, while wearing the gloves 240, may place their hands on the capacitive plates 340, which causes an electrical circuit to be completed. For example, according to embodiments, the operator device 210 may output a signal to the gloves 240 that is received by the capacitive signal detector and amplifier 350 via one or more of the capacitive plates 340. The capacitive signal detector and amplifier 350 may detect the signal received from the gloves 240 and may transmit the signal to the saw controller 310. The saw controller 310 may be configured to receive the signal from the capacitive signal detector and amplifier 350 and confirm, based on the signal, that the operator is sufficiently ground and that the saw is ready for use. In some embodiments, the functions of the capacitive signal detector and amplifier 350 may be performed by the saw controller 310. For example, the capacitive signal detector and amplifier 350 may be a part of the saw controller 310. As part of the process that enables the system proper connection and capacitance between the gloves and grounds as well as impedance across the body to detect proper connections and usage. This information is used as one of the parameters that are checked like battery levels and system function to assure these systems are working before enabling the system.

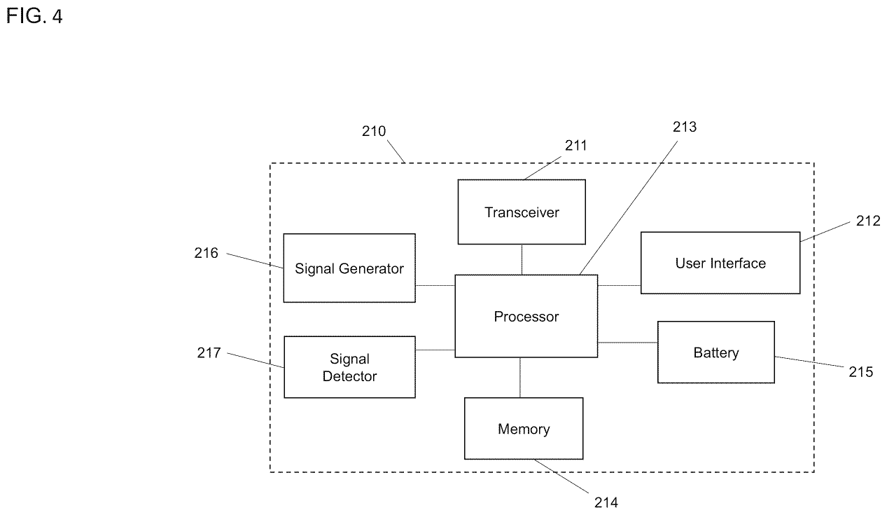

FIG. 4 illustrates a block diagram of the operator device 210. The operator device 210 may include a transceiver 211 (for example, a Bluetooth Low Energy (BLE) radio), a user interface 212, at least one processor 213, a memory 214, a battery 215, a signal generator 216, and a signal detector 217. The transceiver 211 of the operator device 210 may be configured to operate as a transmitter and a receiver. In some embodiments, the transceiver 211 may comprise a single unit or a plurality of units, such as a transmitter and a receiver, configured to perform the functions of a transceiver. The signal generator 216 may be configured to generate signals that are respectively received by the gloves 240 and the signal detector 217 may be configured receive the signals after the signals have respectively passed through the gloves 240.

The user interface 212 may be configured to accept input and display operator system information with respect to a glove status and a battery status. The operator system information may include a connection status of a connection between the operator system 200 and the saw 300, strength of the connection status, arm to arm impedance levels of the operator, glove to ground impedance levels of the operator, ground to ground impedance levels of the operator, and operator condition data, for example, operator heart rate, operator temperature, operator physical activity, etc.

The user interface 212 may include status indicators, for example, lights, speakers, displays, etc, to display the operator system information. For example, the user interface 212 can display connectivity indicators that indicate the connection status level of the connection between the operator system 200 and the saw 300. In some embodiments, for example, the user interface 212 may display a battery level (i.e. degree of charge) of the battery 215 of the operator device 210. The user interface 212 may include input devices (e.g., switches, buttons, touch displays, etc.). For example, the input devices may include a power switch for powering on the operator device 210 and a pairing switch for initiating pairing of the operator device 210 to a saw 300. The memory 214 may store computer instructions that are configured to cause, when executed by the processor 213, the operator device 210 to perform its functions. One skilled in the art would understand that the processor 213 may be a single processor or a plurality of processors configured to perform various functions.

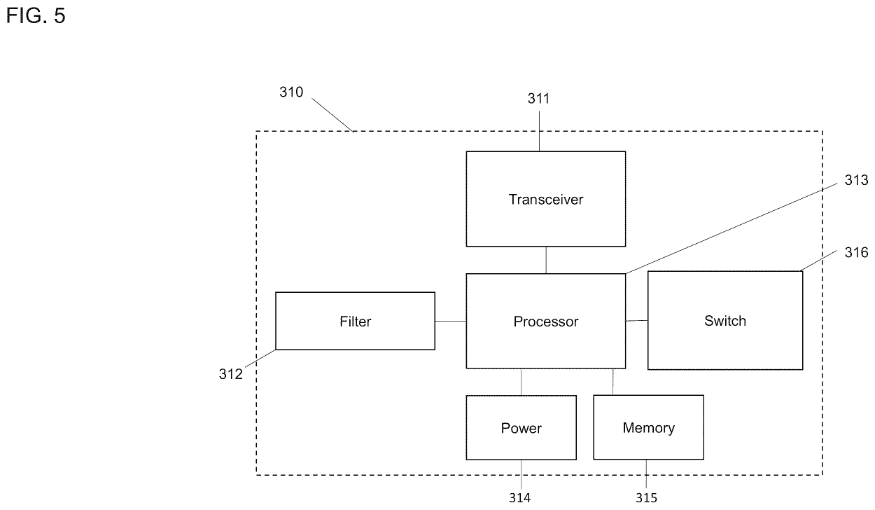

FIG. 5 illustrates a block diagram of the saw controller 310 according to some embodiments. The saw controller 310 may include a transceiver 311 (e.g., a BLE radio), a filter 312, at least one processor 313, a power supply 314, a switch 316, and a memory 317.

The memory 317 may store computer instructions that are configured to cause, when executed by the processor 213, the saw controller 310 to perform its functions. One skilled in the art would understand that the processor 313 may be a single processor or a plurality of processors configured to perform various functions.

The transceiver 211 of the operator device 210 may be configured to connect to and communicate with the transceiver 311 of the saw 300. The filter 312 (e.g. bandpass filter) may be configured to allow frequencies of a specified range to pass and to block frequencies that are outside of the specified range. The filter 312 may enhance the selectability between the operator system 200 and the saw 300. The switch 316 may be configured to toggle the current flow to ground. The switch may include, for example, an open collector output, a relay, a triode for alternating current (TRIAC), a field-effect transistor (FET), a span, and other electronic controlling devices.

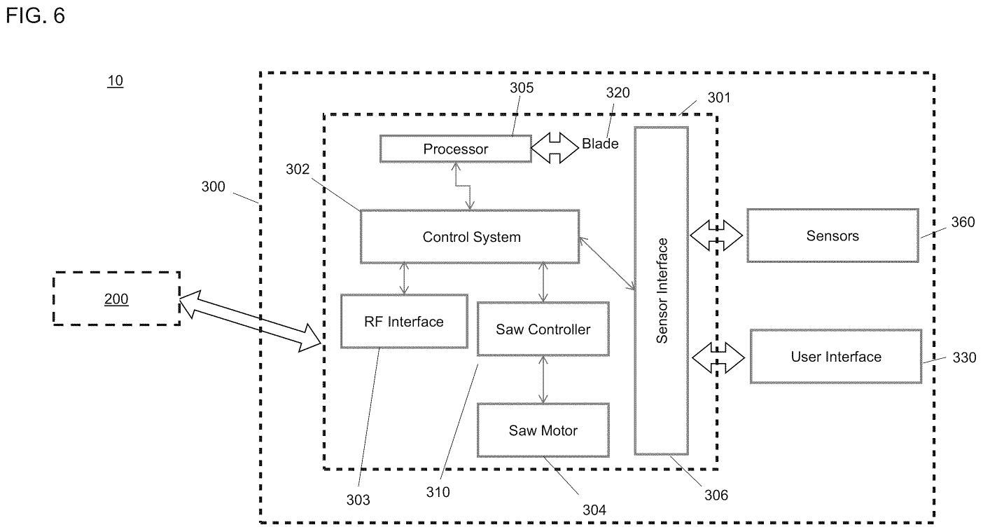

FIG. 6 illustrates a saw safety system according to some embodiments. The saw safety system 10 may comprise the saw 300 and a glove system such as, for example, the operator system 200. The saw 300 may comprise a saw monitor system 301 that includes the saw controller 310, a saw motor 304, a processor 305, a control system 302, a sensor interface 306, and a radiofrequency (RF) interface 303. In some embodiments, the processor 305 may be a plurality of processors configured to perform a variety functions.

With reference to FIG. 6, the saw 300 may further comprise one or more sensors 360. The one or more sensors 360 may include guard sensors configured to monitor a position of a guard on the saw 300, vision sensors configured to monitor surroundings of the saw blade 320, and glove detection sensors configured to detect a presence of the gloves within a range of the saw 300. The one or more sensors may include, but is not limited to, a camera, metal detector, etc.

In some embodiments, the control system 302 and/or the processor 305 may be implemented by the saw controller 310. The control system 302 may be connected to the sensor interface 306, the RF interface 303, and the processor 305.

The sensor interface 306 may be connected to the one or more sensors 360 and the user interface 330. The RF interface 303 may be configured to transmit and/or receive RF signals between the saw 300 and the operator system 200 for operator identification and pairing. The saw controller 310 may verify the RF signal from the operator device 210 for another layer of validation when many machines may be located within a room to prevent misidentification and assure the proper RF connection with the saw 300 and the operator device 210.

User identification may be required to start the saw 300. In some embodiments, the saw controller 310 may be configured to identify a Globally Unique Identifier (GUID) of an operator that is requesting to use the saw 300 or an operator that is detected near the saw 300 and to verify that the operator is authorized to use the saw 300. For example, the memory 214 of the operator device 210 may be configured to store the GUID of the operator, the operator device 210 may cause the GUID to be sent via a conductive pathway or wirelessly (e.g., via BLE) to the saw controller 310, and the saw controller 310 may be configured to verify whether the operator is authorized to use the saw 300 based on the GUID.

The saw 300 may be connected to the internet or preconfigured with a whitelist (a list of users that are authorized to operate specified equipment) that includes the operators authorized to use the saw 300. The whitelist may be stored as a database. The database may be provided in the memory 317 of the saw controller 310 or externally in, for example, a cloud computing environment or an externally provided memory device.

In some embodiments, the saw safety system 10 may be equipped with hardware and/or software configured to perform near-field communication (NFC), which enables auto pairing between the operator device 210 and the saw controller 310. For example, in response to the operator device 210 being within a specified distance of the saw controller 310, the operator may press the pairing switch on the operator device 210 and the pairing switch on the saw 300 simultaneously to automatically pair the operator device 210 and the saw controller 310.

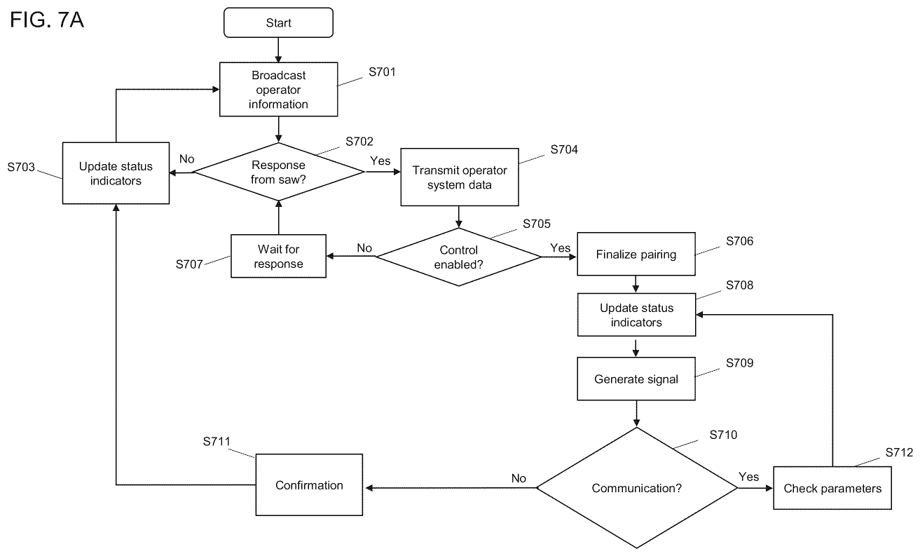

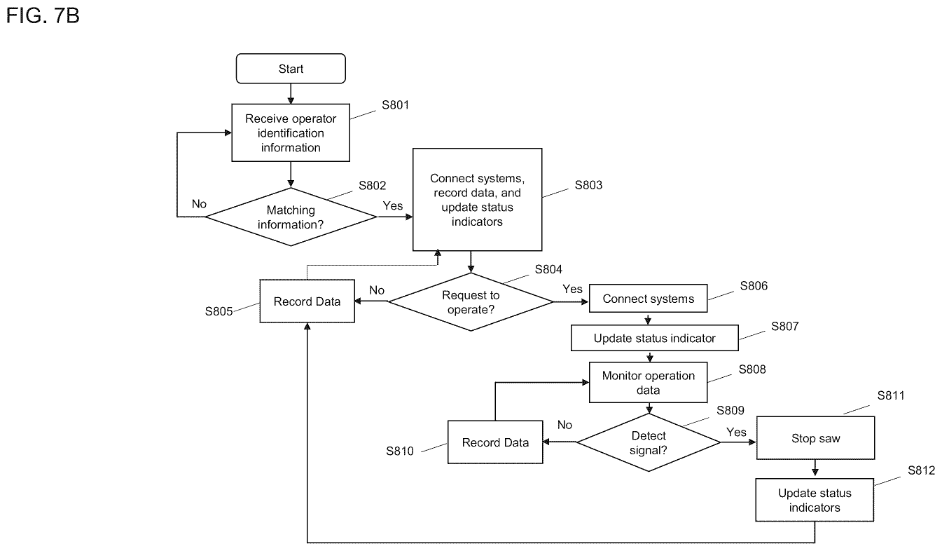

FIGS. 7A-7B illustrate flowcharts showing multi-level operator and saw control interfacing. The operator device 210 and the saw controller 310 may work together to enable a connection between the operator system 200 and the saw 300, and may allow the saw controller 310 to monitor various parameters of the operator system 200. For example, the saw controller 310 may monitor received signal strength indicator (RSSI) signal strength for determining proximity, operator impedance for determining proper usage of the gloves and body grounding, battery life of the operator device 210, various impedance operator levels across the body of the operator, and a health status of the operator.

With reference to FIG. 7A, a flow chart of a process performed by an operator device according to some embodiments described below.

The operator device 210 may broadcast operator identification information (operation S701). For example, the operator device 210 may broadcast a BLE GUID of the operator. If a response (e.g., from the saw controller 310) to the broadcast is not received by the operator device 210 (operation S702), the operator device 210 may update a status indicator to indicate that the operator device 210 was unable to connect with a saw (operation S703) and continue to broadcast the operator information (operation S701). For example, the operator device 210 may not receive a response if there are no available saws in the proximity of the operator and the operator device 210, and the operator device 210 may set an LED of the user interface 212 to red.

If a response to the broadcast is received by the operator device 210 (operation S702), the operator device 210 may transmit operator system data to the saw controller 310 (operation S704). For example, the operator device 210 may receive a response from a saw controller 310 of a saw 300 in proximity to the operator device 210 and may then transmit, for example via BLE radio, the operator system data to the saw controller 310 of the saw 300 in proximity. The operator system data may include operator data, battery data, switch status, operator parameters, etc.

The operator device 210 may determine whether the operator has requested control of the saw 300 (operation S705). If the operator device 210 determines that control of the saw 300 has not been requested and enabled, the operator device 210 may continue to wait for a response from the saw controller 310 of the saw 300 (operation S707). If the operator device 210 does determine that control of the saw 300 has been requested and enabled, the operator device 210 may finalize the pairing with the saw controller 310 of the saw 300 (operation S706). The operator device 210 may update the status indicator to indicate that the systems are currently paired and that the operator device 210 may successfully communicate with the saw controller 310300 (operation S708). For example, the operator device 210 may set the LED of the user interface 212 to green.

The operator device 210 may begin generating signals (e.g. communications) between the operator device 210 and the saw controller 310 (operation S709) and continuously monitor to determine whether the operator device 210 and the saw controller 310 are in communication (operation S710). For example, the operator device 210 may determine that there is communication based on receiving a communication response from the saw controller 310, and may determine that there is no communication (e.g., communication stopped) if a communication response from the saw controller 310 is not received by the operator device 210. Upon stoppage of communication between the operator device 210 and the saw controller 310, the operator device 210 may confirm the stoppage of the communication (operation S711). For example, the operator device 210 may perform confirmation to verify that communication between the operator device 210 and the saw controller is stopped. After the confirmation, the operator device 210 may update the status indicator to indicate that the operator device 210 is not connected with the saw controller 310 (operation S703). For example, the operator device 210 may set the LED of the user interface 212 back to red. If communication between the operator device 210 and the saw controller 310 continues, the operator device 210 may continue to check parameters (operation S712) and update the status indicator (operation S708).

With reference to FIG. 7B, an example pairing and operating process of the saw safety system 10 according to some embodiments is described below.

The saw controller 310 of the saw 300 may receive operator identifier information from an operator device 210 (operation S801). For example, the saw controller 310 may receive a BLE GUID from the operator device 210. The saw controller 310 may determine whether the received operator identification information matches operator identifiers authorized to operate the saw 300 (operation S802). For example, the saw controller 310 may compare the GUID of the operator to a whitelist of authorized GUIDs and determine whether the requesting GUID is included in the whitelist. If the saw controller 310 determines that the operator identification information does not match with any of the operators authorized to operate the saw 300 (operation S802), the saw controller 310 may continue to monitor and repeat the process of receiving operator identification information for operators (operation S801). If the saw controller 310 determines that the operator identification information does match one of the operators authorized to operate the saw 300 (operation S803), the saw controller 310 may connect to the operator device 210, record data regarding the operator device 210, and update a status indicator to indicate that the saw controller 310 is connected to the operator device 210 (operation S803). For example, the saw controller 310 may establish a BLE connection with the operator device 210, record proximity data of the operator device 210 in the memory 317, and may set an LED of the user interface 330 to blue.

The saw controller 310 may then determine whether the operator has requested to operate the saw 300 (operation S804). For example, the operator may press an input device of the user interface 330 on the saw 300 to start up the saw 300 and/or place their gloved hands on the capacitive plates 340 to confirm proper signal.

If the saw controller 310 does not detect a request to operate the saw 300 by the operator (operation S804), the saw controller 310 may record data being transmitted in the memory 317 (operation S805) and repeat operation S803.

If the saw controller 310 does detect a request to operate the saw 300 (operation S804), the saw controller 310 may cause the saw 300 to start up (operation S806), update the status indicator to indicate that the saw 300 is in operation (operation S807), and continuously monitor operation data (operation S808). For example, the saw controller 310 may cause the saw blade 320 to turn and may set the LED of the user interface 330 to green.

If the operator device 210 and/or the saw controller 310 detects that the signal has been shunted, the saw controller 310 may activate the emergency stop of the saw 300 (operation S811), update the status indicator to indicate that the operation of the saw 300 has been stopped (operation S812), and record measured data (operation S805). For example, if an event occurs, such as one of the gloves 240 of the operator coming into contact with the saw blade 320 and the signal being shunted, the saw controller 310 may cause the saw blade 320 to stop. The saw controller 310 may set the LED of the user interface 330 to red and record the data corresponding to the event in the memory 317.

If the operator device 210 and/or the saw controller 310 does not detect that the signal has been shunted, the saw controller 310 may continuously record the operation data (operation S810) and monitor the operation data during operation of the saw 300 (operation S808).

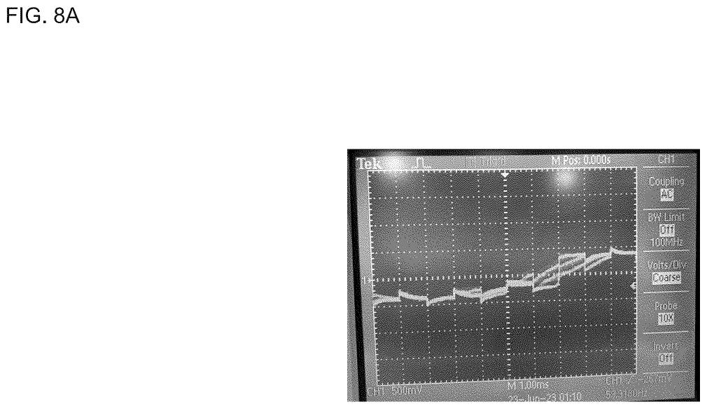

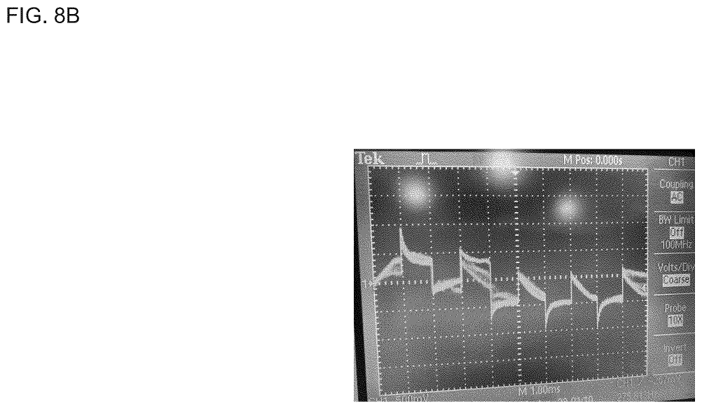

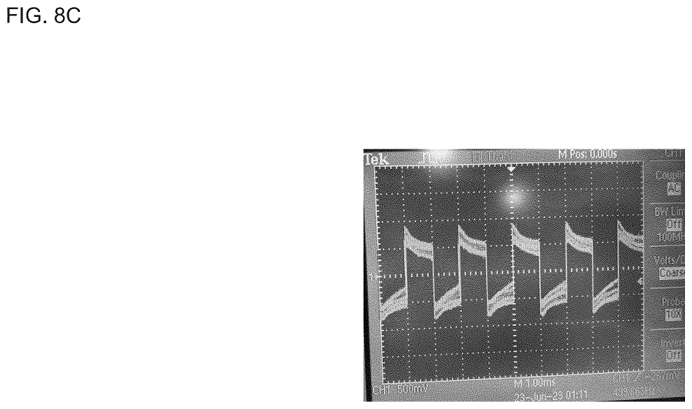

FIG. 8A-8C illustrates various levels of signal depending on the proximity to the ground plane (e.g. saw 300) and various level of body interconnection to the operator control device ground. FIG. 8A depicts the signal levels based on a configuration with one body connection. For example, boding grounding via one conductive element on a foot of the operator. FIG. 8B depicts the signal levels of two body ground connections that are placed slightly away from a ground plane. For example, body grounding via one conductive element on each foot of the operator, with the operator is standing near the saw 300. FIG. 8C depicts the signal levels of two body ground connections positioned close in proximity to the ground plane. For example, body grounding via one conductive element on each foot of the operator, with the operator standing in front of the saw 300. As shown in FIG. 4, better proximity to a ground plane (i.e, closer to the saw 300) creates a cleaner and larger detection signal at the saw.

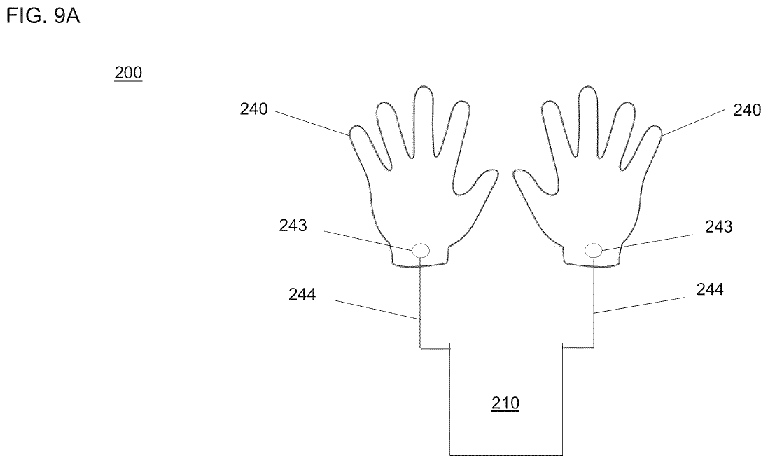

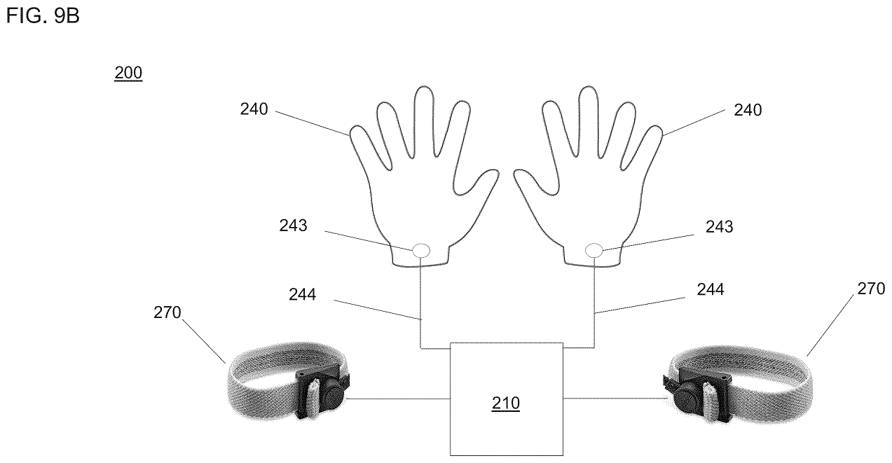

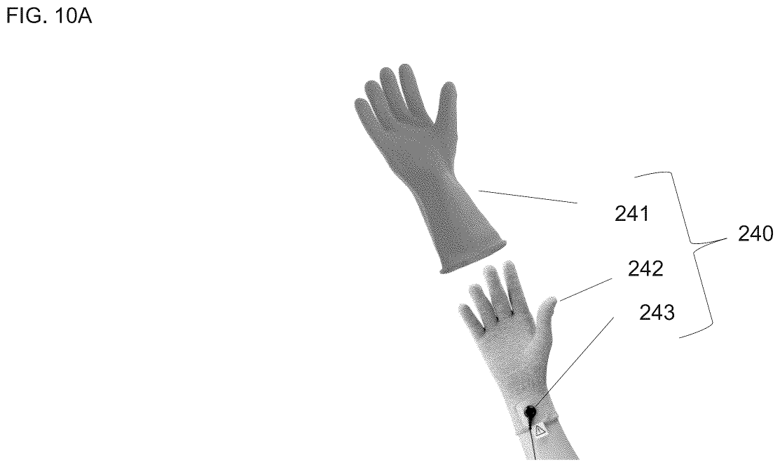

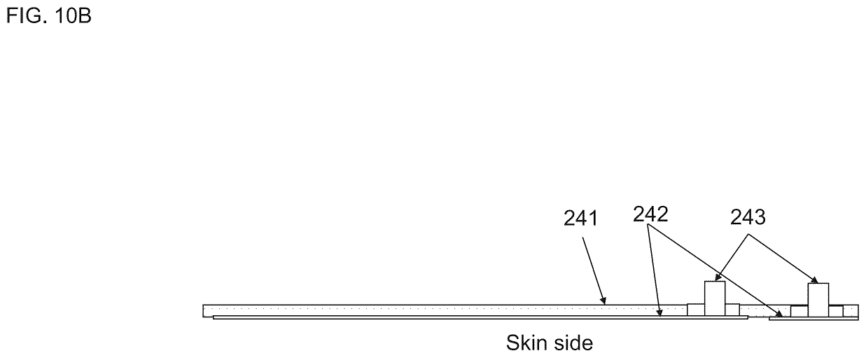

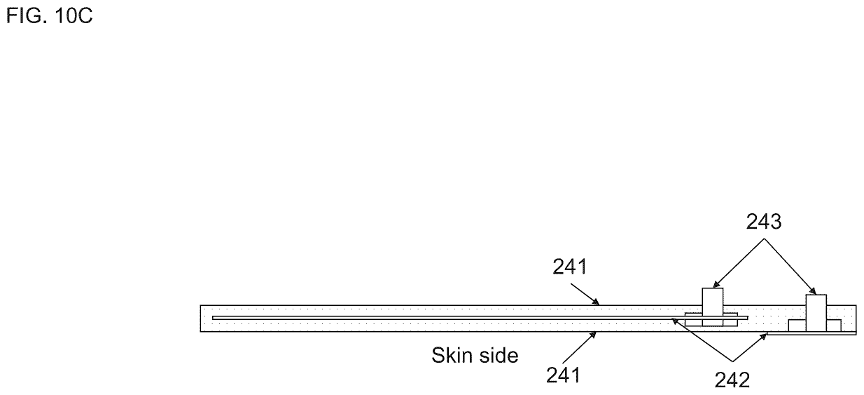

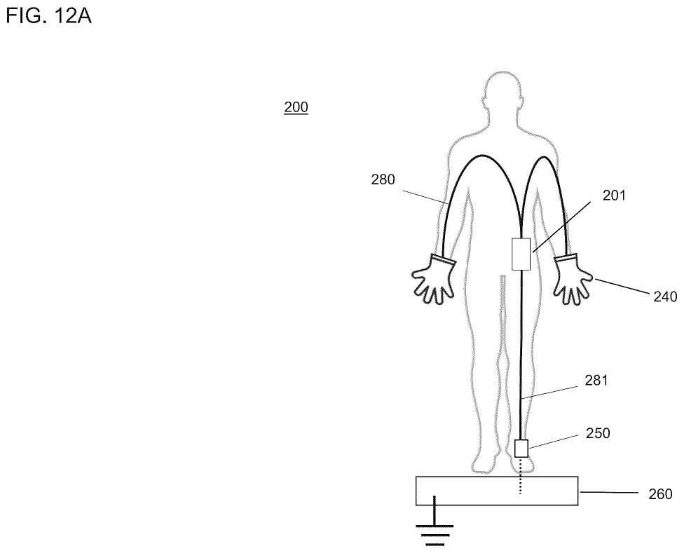

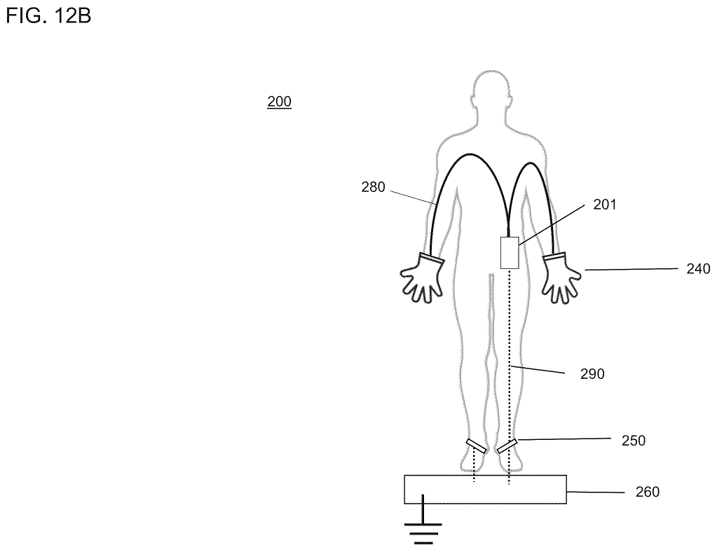

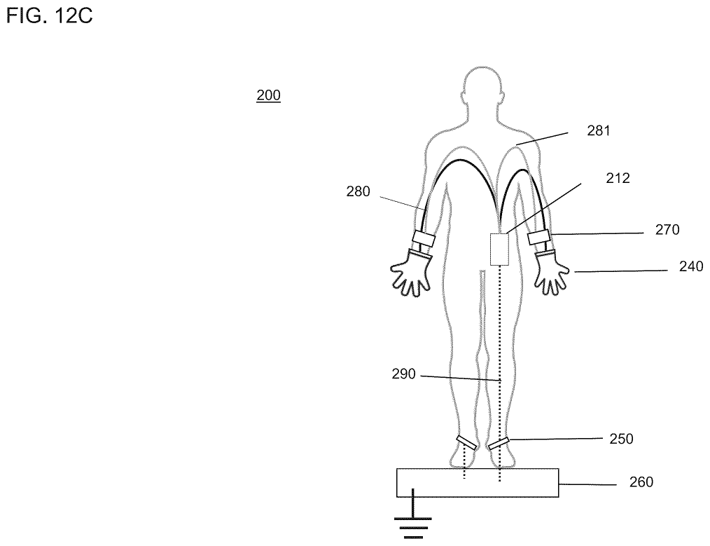

FIG. 9A-9B illustrates the operator system 200 comprising the gloves 240 and the operator device 210 according to some embodiments of the disclosure. The gloves 240 may be connected to the operator device 210 via connection snaps 243 and signal wires 244 and the operator device 210 may be configured to wirelessly connect to the saw monitor system 301. According to embodiments, each of the gloves 240 may include two connection snaps 243 (e.g., refer to FIGS. 10B-10C) and, for each of the gloves 240, the signal wire 244 may be connected to both connection snaps 243 of the glove 240. For example, the signal wire 244 may be a type of cable (e.g., a multi-conductor cable) that includes two conductive paths that respectively connect to the connection snaps 243 of the glove 240. According to embodiments, for each of the gloves 240, the signal wire 244 connected to the glove 240 may be provided in plural as separate wires that are respectively connected to the connection snaps 243 of the glove 240. In some embodiments, the saw safety system 10 may further incorporate wrist grounding in the grounding of the operator device 210. With reference to FIG. 9B and FIG. 12C, grounding wrist straps 270 may be attached to wrists of the operator and may be connected, for example, via tethers, to the operator device 210 to further ground the operator device 210.

FIG. 10A illustrates material construction for the gloves 240 according to some embodiments of the disclosure. In some embodiments, the gloves 240 may comprise an insulation layer 241 (i.e., insulation material), a conductive layer 242 (i.e., conductive material), and the connection snaps 243. The connection snaps 243 may be configured to connect the gloves 240 to the operator device 210 such that signal can be generated and signal can be detected, measured, and recorded.

FIG. 10B illustrates material construction cross section for the gloves 240 according to some embodiments of the disclosure. In some embodiments, the gloves 240 may be partially insulated such that an exterior surface of the glove may be the insulation layer 241, and the conductive layer 242 contacts the operator's skin. This configuration may be achieved by the insulation material and the conductive material being two separate gloves that are worn together, as depicted in FIG. 9A, or the gloves 240 may be manufactured with the insulation layer 241 and the conductive layer 242.

FIG. 10C illustrates material construction cross section for the gloves 240 according to some embodiments of the disclosure. In some embodiments, the gloves 240 may be fully insulated with an inner conductive layer. In such configuration, the conductive layer 242 may be manufactured within the insulation layer 241 such that an insulated material surrounds a conductive material, and the insulated material contacts the operator's skin, rather than the conductive material.

With reference to FIGS. 11A-11D and 12A-12C, grounding configurations according to some embodiments of the disclosure are further described. As shown in FIGS. 11A-11D, a conductive element 250 may be used to create a ground path to a conductive surface 260 and then to the saw 300.

In some embodiments, as shown in FIG. 11B, the conductive element 250 may be a conductive shoe 251, and the operator device 210 may be directly grounded to the conductive shoe 251 (refer to FIG. 12A). For example, the conductive shoe 251 may be any type of footwear, such as electrostatic dissipative shoes, configured to discharge static electricity from the operator's body. The conductive shoe 251 may include a connection point 252, such as a snap or clip, to connect the operator device 210 to the conductive shoe 251. The conductive shoe 251 may be configured to contact the conductive surface 260 and create the ground path from the operator device 210 to the saw 300.

In some embodiments, as shown in FIG. 11C, the conductive element 250 may be a shoe strap 253, and the operator device 210 may be directly grounded to the shoe strap 253 (refer to FIG. 12A). The shoe strap 253 may comprise a connection point 252, for example a snap or clip, and a conductive sole 253a. The conductive sole 253a of the shoe strap 253 may be configured to contact the conductive surface 260 and create the ground path from the operator device 210 to the saw 300.

In some embodiments, as shown in FIG. 11D, the conductive element 250 may be the shoe strap 253, which may further include a resistor 254 and a ribbon 255 for body grounding. The resistor 254 may be connected to the conductive sole 253a and the ribbon 255. The ribbon 255 may be placed inside the operator's shoe or sock and the conductive sole 253a may contact the conductive surface 260, thereby grounding the operator's body and creating the ground path to the saw 300.

FIGS. 12A-12C illustrate various grounding configurations and glove combinations according to some embodiments of the disclosure. In various embodiments, the gloves 240 may be connected to the operator device 210 via the wiring 280, which may connect to the connection snaps 243. The operator device 210 may be configured to be mounted on the operator, for example, via a belt or waistband.

In some embodiments, with reference to FIG. 12A, the operator device 210 may be grounded via direct connection to the conductive element 250 (e.g. the conductive shoe and/or the shoe strap). For example, a grounding wire 281 may span from the operator device 210 to the connection point 252 of the conductive shoe 251 or the shoe strap 253 that connects to the conductive sole 253a in contact the conductive surface 260. In such configuration, the system is not ground via the operator's body. The ground on the bottom of the conductive shoe 251 and/or the conductive sole 253a of the shoe strap 253 may be connected to the ground on the operator device 210, thereby completing the signal path.

In some embodiments, with reference to FIG. 12B, the operator system 200 may be configured such that the operator's body is utilized as part of the grounding. That is, the system is ground through the operator's body to the shoe strap 253 worn by the operator, which may be in contact with the conductive surface 260 via the conductive sole 253a. The ground path 290 may be transferred along the operator's body to the conductive surface 260 as depicted in FIG. 12B.

In some embodiments, the operator system 200 may be further configured to utilize the grounding wrist straps 270. For example, as illustrated in FIG. 12C, the system may implement grounding wrist straps 270 in conjunction with body grounding (e.g., ground path 290) and the shoe strap 253, to ground the system. That is, the system may ground to the body first with the shoe strap 253, and then the grounding wrist straps 270 may be ground the operator device 210. In some embodiments, the grounding wrist straps 270 may be utilized in conjunction with the direct grounding of the operator device 210 to the conductive sole 253a of the shoe strap 253.

Each of these system configurations may measure impedance between all interconnecting grounds and gloves to assure proper body resistance for the safety feedback of proper equipment configuration.

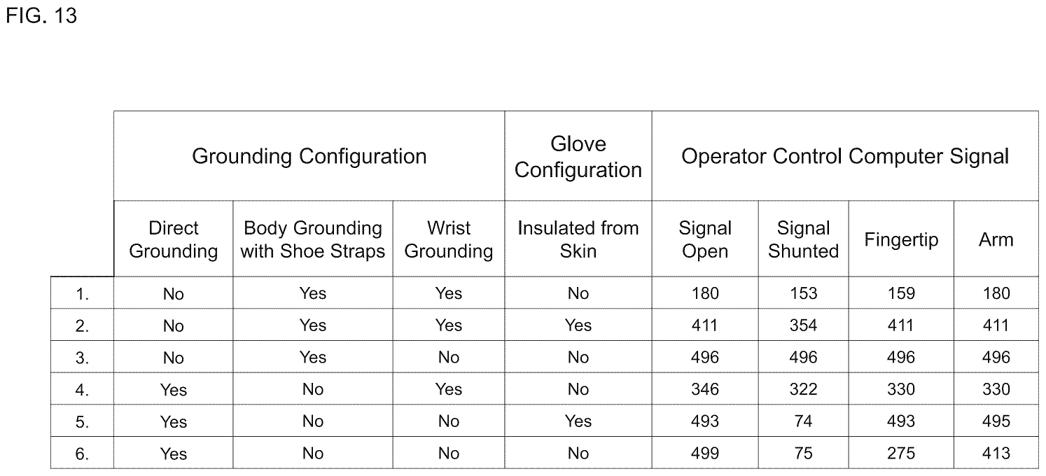

FIG. 13 illustrates the various signal ratios of shunted and non-shunted signals during testing of various grounding schemes and glove configurations. The “Direct Grounding” column represents a configuration in which the operator device 210 is directly grounded (e.g., refer to FIG. 12A). The “Body Grounding with Shoe Straps” represents a configuration in which the system is ground by way of the operator's body and the shoe straps 253 (e.g., refer to FIG. 12B). The “Wrist Grounding” represents a configuration in which grounding wrist straps 270 were included in grounding (e.g., refer to FIG. 12C). The grounding configurations tested include “Direct Grounding,” and “Body Grounding with Shoe Straps” configurations, both with and without the inclusion of “Wrist Grounding”. In addition, different glove configurations were tested in conjunction with said various grounding schemes. The column labeled “Insulated from Skin” represents the glove configuration. The gloves 240 that are not insulated from the operator's skin, for example FIG. 10B, is represented as “No” in the “Insulated from Skin” column and gloves 240 that are insulated from the operator's skin, for example FIG. 10C, is represented as “Yes” in the “Insulated from Skin” column.

The column labeled “Signal Open” represents a signal ratio of non-shunted signal values detected by the operator device 210 and the column labeled “Signal Shunted” represents a signal ratio of shunted signal values detected by the operator device 210 (e.g., caused when the operator touches the saw blade 320), and the larger the difference between open and shunted signal ratios, the more noticeable the signal detection. The grounding/glove configurations that produce the largest difference between shunted and non-shunted signal ratios are considered to have the best overall performance. That is, when there is a noticeable difference in signal detection, the operator device 210 and/or the saw controller 310 can more accurately detect when the operator touches the saw blade 320 and perform E-stop to prevent harm to the operator and/or the saw 300. Additionally, the testing looked at signals detected at the fingertip (“Fingertip” column of FIG. 13) and the arm (“Arm” column of FIG. 13) of the operator to see how signals propagate depending on additional body converge requirements and false trip opportunities. The signals in FIG. 13 are represented as values (ratios) between 0 and 1024, where 5V is 1024 and OV is 0.

Six experiments (1-6) were performed with varying combinations of grounding and glove configurations. The first three experiments (1-3) were performed using body grounding. Experiments 1 and 2 utilized body grounding with both shoe straps and grounding wrist straps and Experiment 3 utilized body grounding with shoe straps and without grounding wrist straps. Further, Experiment 1 used gloves that are not insulated from the skin and Experiment 2 used gloves that are insulated from the skin.

The second three experiments (4-6) were performed using direct grounding of the operator device. Experiment 4 utilized direct grounding of the operator device and grounding wrist straps. Experiments 5 and 6 utilized direct grounding without grounding wrist straps. Experiment 5 used gloves that are insulated from the skin and Experiment 6 was performed with gloves that are not insulated from the skin.

As shown in FIG. 13, the configurations in Experiments 1-2 and 4-6 produced noticeable results when evaluating the difference between the open signals and shunted signals.

Additionally, as shown in FIG. 13, with Experiments 4 and 6, the signals detected at the operator's fingertip and arm are both smaller than the open, non-shunted signal.

It can be seen from FIG. 13 that gloves configured with insulation contacting the operator's skin cause minimal difference between the open signal and signals detected at the fingertips and arm.

The above description is that of non-limiting examples embodiments of the present disclosure. Various alterations and changes can be made without departing from the spirit and broader aspects of embodiments of the present disclosure, which are to be interpreted in accordance with the principles of patent law including the doctrine of equivalents. This disclosure is presented for illustrative purposes and should not be interpreted as an exhaustive description of all embodiments of the present disclosure or to limit the scope of the claims to the specific elements illustrated or described in connection with these embodiments. For example, and without limitation, any individual element(s) of the present disclosure may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. Embodiments of the present disclosure are not limited to only those example embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A saw safety system comprising:
a saw comprising a saw controller and a blade; and
an operator system comprising:
an operator device,
gloves configured to be worn by an operator and configured to electrically connect to the operator device,
a conductive surface grounded to the saw, and
a conductive element configured to be worn by the operator and configured to ground the operator device through contact with the conductive surface, wherein the operator device is configured to:
receive a first signal from the gloves;
determine whether at least one of the gloves has contacted the blade based on the first signal received from the gloves; and
cause, by sending a wireless signal to the saw controller based on determining that at least one the gloves has contacted the blade, the saw controller to stop operation of the blade.

2. The saw safety system according to claim 1, wherein the gloves comprise an insulated layer and a conductive layer.

3. The saw safety system according to claim 2, wherein the insulated layer surrounds the conductive layer and the insulator layer is configured to contact a skin surface of the operator when the gloves are worn by the operator.

4. The saw safety system according to claim 2, wherein the conductive layer is configured to contact a skin surface of the operator when the gloves are worn by the operator.

5. The saw safety system according to claim 1, wherein the conductive element is connected to the operator device via a wire, and the operator device is grounded via the wire and the conductive element.

6. The saw safety system according to claim 1, wherein the conductive element is a shoe strap and the operator device is configured to be grounded by the shoe strap through an electrical pathway that includes a body of the operator.

7. The saw safety system according to claim 1, wherein the operator device is further configured to be mounted to a body of the operator.

8. The saw safety system according to claim 1, wherein the operator system is configured to store a unique identifier that is associated with the operator in a memory, and send the unique identifier to the saw controller, and
wherein the saw controller is configured to determine whether the operator is authorized to operate the saw based on the unique identifier and allow operation of the saw by the operator based on determining that the operator is authorized to operate the saw.

9. The saw safety system according to claim 1, wherein the operator device is configured to communicate with the saw controller via Bluetooth Low Energy (BLE) signals.

10. The saw safety system according to claim 1, wherein the saw further comprises capacitive plates, and
wherein the saw controller is further configured to verify proper grounding between the operator and the saw based on receiving a second signal via the capacitive plates, that is received based on the operator wearing the gloves and placing the gloves on the capacitive plates.

11. A method of stopping a saw including a saw controller and a blade, the method comprising:
receiving, by an operator device, a first signal from a glove worn by an operator via an electric pathway that connected the glove to the operator device;
determining, by the operator device, whether the glove has contacted the blade based on the first signal that is received; and
transmitting, from the operator device to the saw controller via wireless communication, a wireless signal based on determining that the glove has contacted the blade, and
stopping, by the saw controller, movement of the blade based on receiving the wireless signal from the operator device.

12. The method according to claim 11, wherein the saw further includes a capacitive plate, and
wherein the method further comprises:
receiving, by the saw controller, a second signal via the capacitive plate, based on the operator wearing the glove and placing the glove on the capacitive plate; and
verifying, by the saw controller, proper grounding between the operator and the saw based on the second signal.

13. The method according to claim 11, wherein the glove includes an insulated layer and a conductive layer.

14. The method according to claim 13, wherein the insulated layer surrounds the conductive layer and the insulator layer is configured to contact a skin surface of the operator when the glove is worn by the operator.

15. The method according to claim 13, wherein the conductive layer is configured to contact a skin surface of the operator when the glove is worn by the operator.

16. The method according to claim 11, wherein a conductive element worn by the operator is connected to the operator device via a wire, and the operator device is grounded via the wire and the conductive element.

17. The method according to claim 11, wherein the operator device is configured to be grounded by a shoe strap worn on a shoe of the operator through an electrical pathway that includes a body of the operator.

18. The method according to claim 11, further comprising:
sending, from the operator device to the saw controller, a unique identifier that is associated with the operator, and
determining whether the operator is authorized to operate the saw based on the unique identifier and allowing operation of the saw by the operator based on determining that the operator is authorized to operate the saw.

19. The method according to claim 11, wherein the operator device is further configured to be mounted to a body of the operator.

20. A non-transitory computer-readable storage medium storing computer code which, when executed by at least one processor, causes the at least one processor to:
receive a first signal from gloves worn by an operator via an electric pathway that connects the gloves to the at least one processor;
determine whether at least one of the gloves has contacted a blade of a saw based on the first signal that is received; and
transmit, via wireless communication, a command to the saw to stop movement of the blade based on determining that the at least one of the gloves has contacted the blade.
